(19) United States
(12) Patent Application Publication
(10) Pub. No.: US 2023/0060484 A1
(43) Pub. Date: Mar. 2, 2023

(54) LASER PROCESSING APPARATUS

(71) Applicant: Panasonic Intellectual Property Management Co., Ltd., Osaka (JP)

(72) Inventors: HISAYUKI OGUCHI, Hyogo (JP); KEIJI NARUMI, Saitama (JP)

(21) Appl. No.: 18/048,172

(22) Filed: Oct. 20, 2022

Related U.S. Application Data
(63) Continuation of application No. PCT/JP2021/016753, filed on Apr. 27, 2021.

(30) Foreign Application Priority Data
May 19, 2020 (JP) 2020-087628

(51) Int. Cl. B23K 26/70; B23K 26/06

(52) U.S. Cl. CPC B23K 26/705; B23K 26/0665; B23K 26/0643; B23K 26/0648

(57) ABSTRACT

A laser processing apparatus includes at least a laser oscillator, optical fiber (30), and laser head (40). Laser head (40) includes at least first and second shield glasses (45) and (47) and first and second light receivers (51) and (52) inside second housing (41). In first and second shield glasses (45) and (47), first and second coating films (46) and (48) are respectively provided on light receiving surfaces of laser light (LB). First light receiver (51) receives laser light (LB) reflected by first coating film (46) and outputs a first light receiving signal, and second light receiver (52) receives laser light (LB) reflected by peripheral portion (48b) of second coating film (48) and outputs a second light receiving signal.

This application is a continuation application of the PCT International Application No. PCT/JP2021/016753 filed on Apr. 27, 2021, which claim the benefit of foreign priority of Japanese patent application No. 2020-087628 filed on May 19, 2020, the contents all of which are incorporated herein by reference.

### TECHNICAL FIELD

The present disclosure relates to a laser processing apparatus.

### BACKGROUND ART

Conventionally, there has been known a laser processing apparatus that performs laser processing on a workpiece at a distant location using an optical fiber. In such a laser processing apparatus, an optical component, for example, a condensing lens, is used for causing laser light emitted from a laser oscillator to appropriately enter an optical fiber.

Meanwhile, when the output of the laser light becomes a large output of the kW class, a part of the laser light is absorbed by the condensing lens, and the temperature rises. In this case, the focal distance of the condensing lens may change due to the thermal lens effect.

Therefore, PTL 1 discloses a method for detecting a change in focal distance corresponding to a change in refractive index distribution of a condensing lens or a change in numerical aperture of laser light by measuring an in-plane temperature distribution of the condensing lens through which the laser beam is transmitted at multiple points with a thermocouple. By correcting the focal position of the laser light based on the detection result, the spot diameter of the laser light with which the workpiece is irradiated can be maintained at an appropriate value.

### CITATION LIST

### Patent Literature

PTL 1: Japanese Patent Publication No. 5558629

### SUMMARY OF THE INVENTION

### Technical Problem

Incidentally, the state of the laser oscillator may change due to the influence of temperature rise or the like during long-term use. For example, there is a case where the optical axis of the laser light fluctuates from the initial stage. In addition, in a case where the output of the laser light is greatly changed and used, the divergence angle of the laser light may change before and after the output change.

In such a case, the numerical aperture of the laser beam incident on the optical fiber fluctuates, and the beam quality and the spot diameter of the laser light with which the workpiece is irradiated may not be maintained at desired values. As a result, there is a possibility that the machining accuracy of the workpiece is impaired.

However, in the conventional method disclosed in PTL 1, since the refractive index distribution of the condensing lens is indirectly obtained using the thermocouple, it is difficult to detect such a change in the numerical aperture in a short time and in real time.

An object of the present disclosure is to provide a laser processing apparatus capable of detecting the numerical aperture of laser light incident on an optical fiber in a short time and in real time.

### Solution to Problem

In order to achieve the above object, a laser processing apparatus according to the present disclosure includes: a laser oscillator configured to generate laser light; an optical fiber configured to transmit the laser light incident on an incident end; and a laser head configured to receive the laser light transmitted through the optical fiber and irradiate a workpiece with the laser light, in which the laser head includes: a housing; a first optical component and a second optical component each disposed inside the housing; and a first light receiver and a second light receiver each disposed inside the housing, the first optical component is disposed at a position closer to an emission end of the optical fiber than the second optical component is, the first optical component is provided with a first coating film having a predetermined reflectance on at least one of light receiving surfaces of the laser light, the second optical component is provided with a second coating film on at least one of light receiving surfaces of the laser light, the first light receiver receives the laser light reflected by the first coating film and outputs a first light receiving signal corresponding to the laser light received, and the second light receiver receives the laser light reflected by a peripheral portion of the second coating film and outputs a second light receiving signal corresponding to the laser light received.

### Advantageous Effects of Invention

According to the present disclosure, it is possible to detect the numerical aperture of laser light incident on an optical fiber and a change in the numerical aperture in a short time and in real time.

### BRIEF DESCRIPTION OF THE DRAWINGS

FIG. 1 is a schematic configuration diagram of a laser processing apparatus according to a first exemplary embodiment.

FIG. 2 is a schematic cross-sectional view of an optical fiber.

FIG. 3 is a schematic view of the inside of a laser head.

FIG. 4 is a schematic view illustrating a beam profile of laser light.

FIG. 5 is a diagram illustrating an example of a temporal change of a first light receiving signal and a second light receiving signal.

FIG. 6 is a diagram illustrating relative intensities of the first light receiving signal and the second light receiving signal with respect to an output of laser light and an NA.

FIG. 7 is a diagram illustrating a relationship between an incident position of a laser beam on an incident end surface of an optical fiber and an NA of laser light emitted from the optical fiber according to a second exemplary embodiment.

FIG. 8 is a schematic configuration diagram of a film forming apparatus for a second coating film according to a third exemplary embodiment.

FIG. 9 is a diagram illustrating an arrangement relationship between an optical component and a fixture during film formation.

FIG. 10 is a diagram illustrating a film thickness distribution of a second coating film.

FIG. 11 is a diagram illustrating a relationship between a wavelength of laser light and reflectance of a second coating film.

### DESCRIPTION OF EMBODIMENT

Exemplary embodiments of the present disclosure will be described below with reference to the drawings. The following explanation of preferable exemplary embodiments is merely examples in nature, and is not intended to limit the present disclosure, its application, or its use.

### First Exemplary Embodiment

### [Configuration of Laser Processing Apparatus and Optical Fiber]

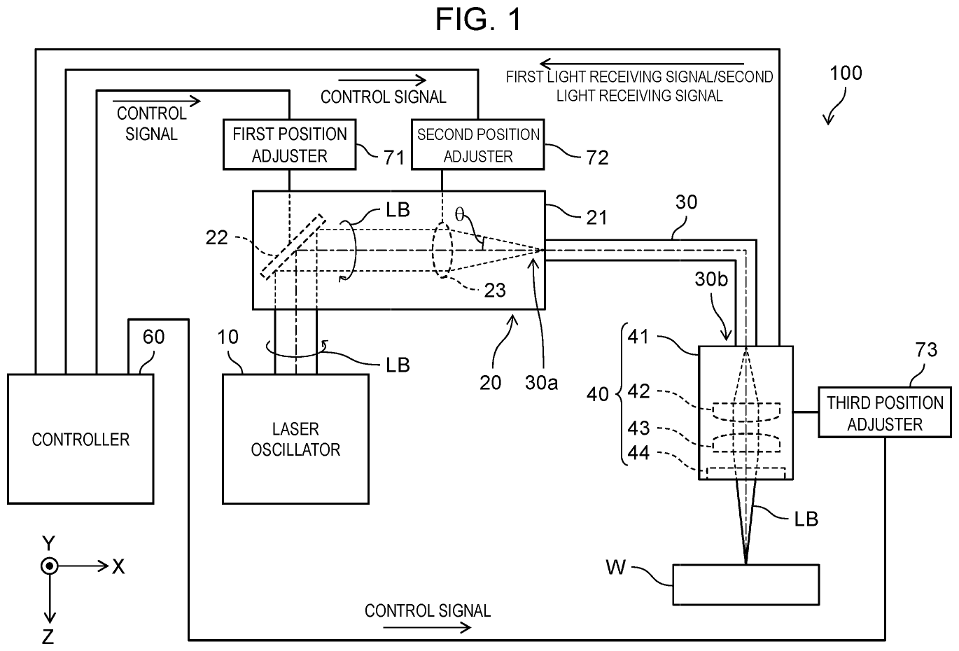

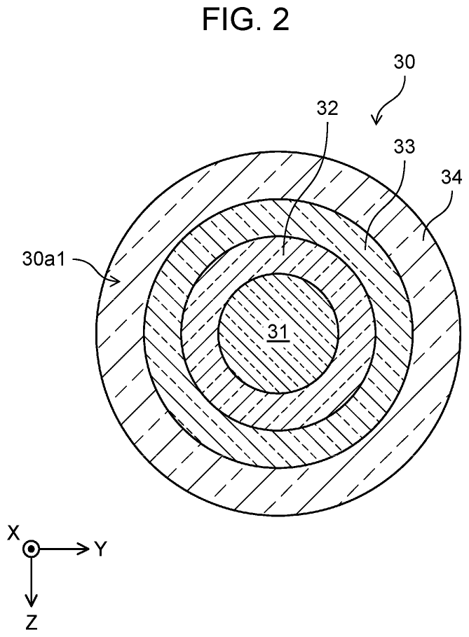

FIG. 1 is a schematic configuration diagram of a laser processing apparatus according to the present exemplary embodiment, and FIG. 2 is a schematic cross-sectional view of an optical fiber. In the following explanation, a direction perpendicular to incident end surface 30a1 of optical fiber 30 may be referred to as an X-direction, a direction from laser head 40 toward workpiece W may be referred to as a Z-direction, and a direction orthogonal to each of the X-direction and the Z-direction may be referred to as a Y direction. In addition, FIG. 2 is merely a schematic view, and is different from actual dimensions of each part of optical fiber 30.

As illustrated in FIG. 1, laser processing apparatus 100 includes at least laser oscillator 10, optical coupler 20, an optical fiber 30, laser head 40, and controller 60. Note that laser processing apparatus 100 includes a power source for driving laser oscillator 10 and the like, but illustration and explanation thereof are omitted for convenience of explanation.

Laser oscillator 10 emits laser light LB. In the present exemplary embodiment, the wavelength of laser light LB is about 950 nm to 1000 nm. However, the value is not particularly limited thereto, and another value may be used.

Laser oscillator 10 according to the present exemplary embodiment is a semiconductor laser light source (DDL; Direct Diode Laser) that directly uses light output from the semiconductor laser. In addition, a plurality of semiconductor laser arrays including a plurality of laser light emitters is used as the DDL light source.

Optical coupler 20 includes at least first housing 21, reflection mirror 22, and first condensing lens 23, and reflection mirror 22 and first condensing lens 23 are accommodated in the inside of first housing 21 while maintaining a predetermined arrangement relationship with each other. In addition, first housing 21 has a light exit port (not illustrated) into which laser light LB emitted from laser oscillator 10 is incident, and a light emission port (not illustrated) to which incident end 30a of optical fiber 30 is connected.

Reflection mirror 22 reflects laser light LB incident on the inside of first housing 21 toward first condensing lens 23. First condensing lens 23 condenses laser light LB reflected by reflection mirror 22 so as to be incident on incident end surface 30a1 of optical fiber 30.

As illustrated in FIG. 1, an angle formed by an optical axis of laser light LB and an outermost side of laser light LB in an optical path of laser light LB extending from first condensing lens 23 to incident end 30a of optical fiber 30 is defined as divergence angle θ.

At this time, the numerical aperture (NA) on the incident side of laser light LB is defined by the following Expression (1).

NA=sin θ (1)

In addition, first position adjuster 71 is connected to reflection mirror 22. By driving first position adjuster 71, the angle of the surface of reflection mirror 22 with respect to the incident direction of laser light LB is adjusted. Second position adjuster 72 is connected to first condensing lens 23. By driving second position adjuster 72, first condensing lens 23 moves in at least one of the X, Y, and Z-directions, and the position thereof is adjusted to a desired position.

In the present exemplary embodiment, an initial arrangement relationship between reflection mirror 22 and first condensing lens 23 is set such that laser light LB is incident on first core 31 (see FIG. 2) of optical fiber 30.

However, as will be described later, laser light LB may be incident on second core 33 (see FIG. 2) of optical fiber 30. In this case, first position adjuster 71 and/or second position adjuster 72 are driven to change the incident position of laser light LB on incident end surface 30a1 of optical fiber 30.

In the example illustrated in FIG. 1, both first position adjuster 71 and second position adjuster 72 are disposed outside first housing 21, but in practice, a part of each is provided inside first housing 21. Both first position adjuster 71 and second position adjuster 72 may be disposed inside first housing 21.

Optical fiber 30 receives laser light LB condensed by first condensing lens 23 of optical coupler 20 and transmits laser light LB toward laser head 40.

As illustrated in FIG. 2, optical fiber 30 includes at least first core 31 and second core 33, which are optical waveguides, and first cladding 32 and second cladding 34, and an outer peripheral surface of second cladding 34 is covered with a light shielding coating (not illustrated).

First core 31 has a circular shape in a cross-sectional view and is disposed at the axial center of optical fiber 30. First cladding 32 is disposed coaxially with first core 31 in contact with the outer peripheral surface of first core 31, and has a ring shape in a cross-sectional view. Second core 33 is disposed coaxially with first core 31 in contact with the outer peripheral surface of first cladding 32, and has a ring shape in a cross-sectional view. Second cladding 34 is disposed coaxially with first core 31 in contact with the outer peripheral surface of second core 33, and has a ring shape in a cross-sectional view.

First core 31 and second core 33, and first cladding 32 and second cladding 34 are all made of quartz. However, the refractive index of first cladding 32 is set to be lower than the refractive index of each of first core 31 and second core 33. In addition, the refractive index of second cladding 34 is set to be lower than the refractive index of second core 33.

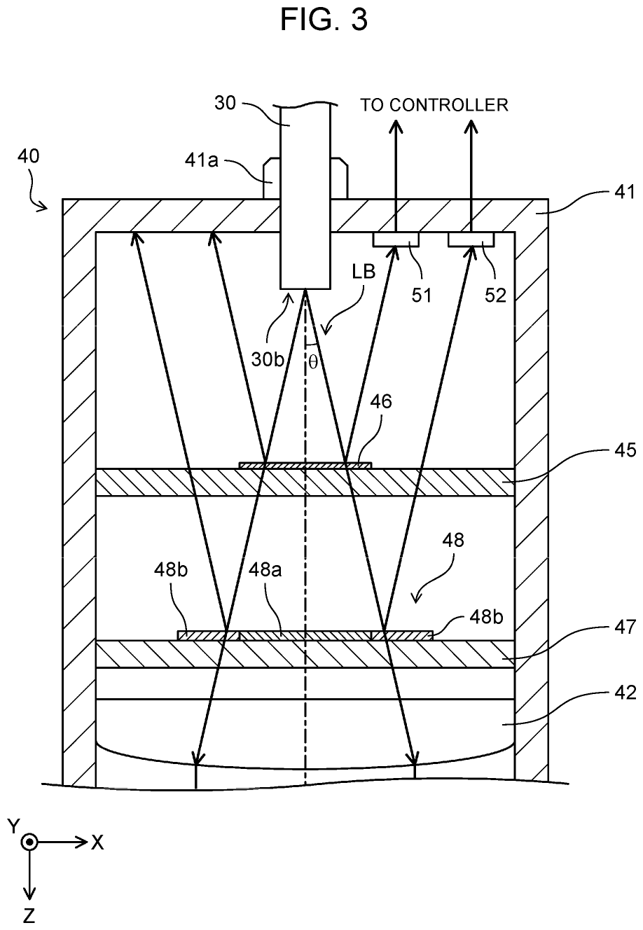

Laser head 40 is configured to receive laser light LB transmitted through optical fiber 30 and irradiate workpiece W with laser light LB, and includes second housing (housing) 41 and a plurality of optical components. As illustrated in FIG. 1, the plurality of optical components include collimation lens 42, second condensing lens 43, and protective glass 44. In addition, the plurality of optical components also include first shield glass (first optical component) 45 and second shield glass (second optical component) 47 described later (see FIG. 3).

Second housing 41 includes connector 41a to which emission end 30b of optical fiber 30 is connected, and a light emission port (not illustrated) through which laser light LB is emitted toward workpiece W. In addition, the plurality of optical components described above are accommodated inside second housing 41 while maintaining a predetermined arrangement relationship with each other.

Laser light LB incident on the inside of second housing 41 from emission end 30b of optical fiber 30 passes through first shield glass 45 and second shield glass 47, and is incident on collimation lens 42 and the second condensing lens 43 which are condensing optical systems.

Collimation lens 42 is configured to convert laser light LB into collimated light, and second condensing lens 43 is configured to condense laser light LB transmitted through collimation lens 42 on the surface of workpiece W.

In addition, third position adjuster 73 is connected to both or at least one of collimation lens 42 and second condensing lens 43. By driving third position adjuster 73, collimation lens 42 and/or second condensing lens 43 moves in the optical axis direction of laser light LB traveling inside second housing 41, and the condensing position of laser light LB is adjusted to a desired position.

In the example illustrated in FIG. 1, third position adjuster 73 is disposed outside second housing 41, but a part thereof is actually provided inside second housing 41. Third position adjuster 73 may be disposed inside second housing 41.

Protective glass 44 is provided to prevent fumes and spatters generated by melting workpiece W by irradiation with laser light LB from entering the inside of second housing 41 and adhering to other optical components.

It goes without saying that other optical components including protective glass 44 are materials that transmit laser light LB. In the present exemplary embodiment, each of the plurality of optical components is made of synthetic quartz. However, the material is not particularly limited thereto, and other materials can be appropriately selected according to the wavelength of laser light LB.

Controller 60 is connected to first to third position adjusters 71 to 73, respectively, and outputs control signals to first to third position adjusters 71 to 73 to control these operations. In addition, the first light receiving signal and the second light receiving signal, which are output signals of first light receiver 51 and second light receiver 52 (see FIG. 3) provided in laser head 40, are input to controller 60. The control signal is generated based on the first light receiving signal and the second light receiving signal.

Note that laser processing apparatus 100 may be provided with a manipulator (not illustrated) that holds laser head 40. The manipulator is, for example, an articulated robot, is connected to controller 60, and moves laser head 40 to a desired position at a desired speed based on an operation command from controller 60. In this manner, laser light LB emitted from laser head 40 is applied to the surface of workpiece W so as to draw a desired trajectory. Another controller (not illustrated) that controls the operation of the manipulator may be provided.

[Configuration of Laser Head]

FIG. 3 is a schematic view of the inside of the laser head. For convenience of explanation, the lower half of laser head 40, for example, second condensing lens 43 and protective glass 44 are not illustrated in FIG. 3.

As illustrated in FIG. 3, emission end 30b of optical fiber 30 is disposed inside second housing 41 through connector 41a. Laser light LB emitted from emission end 30b of optical fiber 30 is transmitted through first shield glass 45 and second shield glass 47 while spreading such that the optical axis and the outermost side form the above-described divergence angle θ, and is incident on collimation lens 42. That is, the numerical aperture represented by Expression (1) is also maintained on the emission side of optical fiber 30. Therefore, the numerical aperture of laser light LB on the incident side and the emission side of optical fiber 30 may be collectively referred to simply as NA of laser light LB below.

First shield glass 45 and second shield glass 47 are disposed between emission end 30b of optical fiber 30 and collimation lens 42 inside second housing 41. In addition, first shield glass 45 and second shield glass 47 are arranged at intervals in the optical axis direction of laser light LB. First shield glass 45 is disposed at a position closer to emission end 30b of optical fiber 30 than second shield glass 47.

First shield glass 45 and second shield glass 47 prevent fumes and the like entering the inside of second housing 41 from adhering to emission end 30b of optical fiber 30.

First shield glass 45 has first coating film 46 on a surface of the light receiving surface of laser light LB on a side close to emission end 30b of optical fiber 30. First coating film 46 is disposed on an optical path of laser light LB incident on first shield glass 45, and has a predetermined reflectance, for example, a reflectance of several tenths % with respect to laser light LB.

Similarly, second shield glass 47 has second coating film 48 on a surface of the light receiving surface of laser light LB on a side close to emission end 30b of optical fiber 30.

Second coating film 48 is disposed on an optical path of laser light LB incident on second shield glass 47. However, unlike first coating film 46, second coating film 48 includes central portion 48a and peripheral portion 48b having different reflectance. The reflectance of central portion 48a is equal to the reflectance of first coating film 46. On the other hand, peripheral portion 48b is formed to have a higher reflectance than central portion 48a. For example, second coating film 48 is formed such that the reflectance of peripheral portion 48b is higher than the reflectance of central portion 48a by about 1 to several tens %.

In the specification of the present application, “same” or “equal” means the same or equal including manufacturing tolerances of the components in laser processing apparatus 100 and first coating film 46 and second coating film 48 and allowable tolerances of an arrangement relationship of the components, and does not mean that the components to be compared are the same or equal in a strict sense.

First coating film 46 and second coating film 48 are thin films made of, for example, a metal oxide dielectric containing a metal such as Ta (tantalum), and are formed to have a refractive index higher than that of synthetic quartz with respect to laser light LB. However, the present invention is not particularly limited thereto, and another configuration can be taken as appropriate. For example, first coating film 46 and second coating film 48 may be dielectric multi-layer films obtained by alternately stacking dielectric films having dielectric constants different from those of synthetic quartz and different from each other. In addition, as second coating film 48, a structure that transmits laser light LB and has different refractive index distributions at central portion 48a and peripheral portion 48b may be used. Also in this case, it is sufficient that the above-described magnitude relationship of the reflectance is satisfied.

In addition, first coating film 46 and second coating film 48 are configured to transmit most of laser light LB, for example, 90% or more, and reflect the rest. The reflectance of first coating film 46 and second coating film 48 is preferably not too high. This is because the loss of laser light LB applied to workpiece W increases. In addition, if the intensity of reflected light inside laser head 40 becomes too high, internal components may be damaged.

That is, the film thicknesses of central portion 48a and peripheral portion 48b of first coating film 46 and second coating film 48 are preferably set so as to transmit most, for example, 90% or more of laser light LB and reflect the rest.

In addition, first light receiver 51 and second light receiver 52 are arranged inside second housing 41. First light receiver 51 is disposed at a position capable of receiving laser light LB reflected by first coating film 46. In addition, second light receiver 52 is disposed at a position spaced apart from first light receiver 51 by a predetermined distance and capable of receiving laser light LB reflected by peripheral portion 48b of second coating film 48.

Both first light receiver 51 and second light receiver 52 are configured by light receiving elements such as known photodiodes. In addition, both first light receiver 51 and second light receiver 52 are configured to output an electric signal corresponding to the amount of received light to controller 60 as an output signal, that is, a first light receiving signal and a second light receiving signal. The NA of laser light LB is derived by controller 60 based on the first light receiving signal and the second light receiving signal input to controller 60. This will be described in detail later.

Both first light receiver 51 and second light receiver 52 have predetermined directivity. That is, each of first light receiver 51 and second light receiver 52 is configured to be capable of receiving only light incident at a light receiving angle in a predetermined range.

[Real-Time monitoring of NA of Laser Light and NA Correction Procedure]

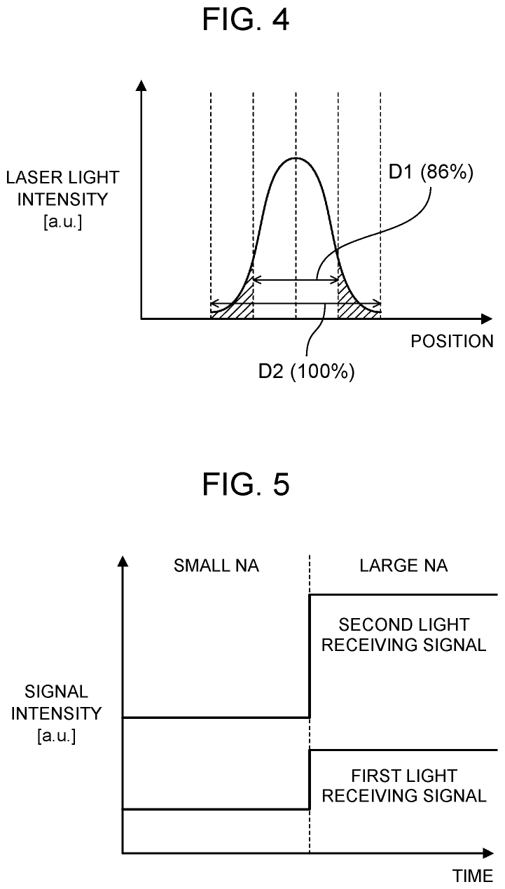

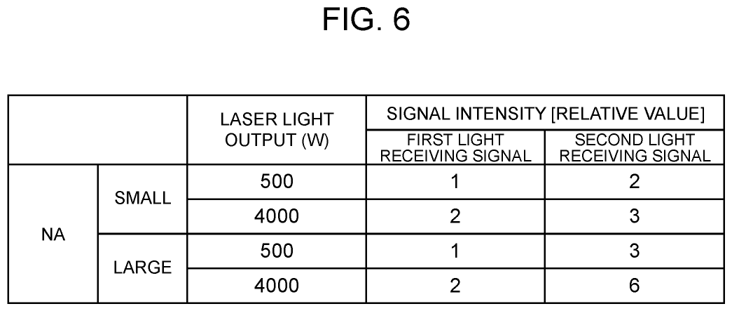

FIG. 4 schematically illustrates a beam profile of laser light, and specifically illustrates a one-dimensional distribution of light intensity of laser light LB. FIG. 5 illustrates an example of temporal changes of the first light receiving signal and the second light receiving signal, and FIG. 6 illustrates relative intensities of the first light receiving signal and the second light receiving signal with respect to the output of the laser beam and the NA. Note that the signal intensity in FIG. 6 is indicated by a relative value in which the signal intensity of the first light receiving signal in a case where the output of laser light LB is 500 W is set to 1.

A portion sandwiched by two broken lines on the inner side in FIG. 4 is a region including 86% of the beam power of laser light LB. In the example illustrated in FIG. 4, a range D1 is set. First light receiver 51 receives the reflected light of laser light LB included in the range D1 and reflected by first coating film 46, and outputs the first light receiving signal.

On the other hand, a portion sandwiched between the two inner broken lines illustrated in FIG. 4 is a region including 100% of the beam power of laser light LB. In the example illustrated in FIG. 4, a range D2 is set. Second light receiver 52 receives the reflected light in which laser light LB included in the range D2 (see the hatched portion in FIG. 4) excluding the range D1 is reflected by peripheral portion 48b of second coating film 48, and outputs the second light receiving signal.

As described above, the NA of laser light LB changes according to the state of laser oscillator 10 and the output change of laser light LB. For example, in the example illustrated in FIG. 5, a case where the output of laser light LB is discontinuously increased is considered. At this time, the signal intensity of both the first light receiving signal and the second light receiving signal increases, but the degree thereof is different. In the example illustrated in FIG. 5, before and after the output change of laser light LB, the rate at which the second light receiving signal increases is higher than the rate at which the first light receiving signal increases. This is because the NA of laser light LB increases due to an increase in the output of laser light LB.

As illustrated in FIG. 6, in a case where the NA of the initial laser light LB is set to a small value, for example, about 0.1, when the output of laser light LB is increased from 500 W to 4000 W(=4 kW), the signal intensity of the first light receiving signal is doubled, whereas the signal intensity of the second light receiving signal is multiplied by 1.5. On the other hand, in a case where the NA of the initial laser light LB is set to a large value, for example, about 0.18, when the output of laser light LB increases from 500 W to 4000 W(=4 kW), the signal intensity of the first light receiving signal becomes three times, and the signal intensity of the second light receiving signal also becomes three times.

As described above, the signal intensity of the first light receiving signal and the signal intensity ratio of the second light receiving signal change according to the output of laser light LB and the change in the NA.

Therefore, the relationship between the signal intensity of the first light receiving signal and the signal intensity ratio of the second light receiving signal and the NA of laser light LB is experimentally obtained in advance, and stored in a storage (not illustrated) provided inside or outside controller 60 as a data table.

Controller 60 is configured to collate the first light receiving signal and the second light receiving signal input from first light receiver 51 and second light receiver 52, respectively, and the intensity ratio thereof with the above-described data table to derive the NA of laser light LB, and detect a change in the NA of laser light LB.

During the operation of laser processing apparatus 100, specifically, while laser light LB is output, the NA of laser light LB and the change thereof can be monitored in real time by operating first light receiver 51, second light receiver 52, and controller 60.

When the derived NA exceeds the predetermined range, controller 60 controls the position of the optical component in optical coupler 20 such that the NA of laser light LB falls within the predetermined range. Specifically, the position of reflection mirror 22 and/or first condensing lens 23 is adjusted by driving and controlling first position adjuster 71 and/or second position adjuster 72. For example, the NA of laser light LB incident on optical fiber 30 is changed by driving first position adjuster 71 to adjust the angle of the surface of reflection mirror 22. In addition, the NA of laser light LB incident on optical fiber 30 is changed by driving second position adjuster 72 to adjust the position of first condensing lens 23.

The predetermined range is appropriately changed according to the output of laser light LB, the machining accuracy required for the laser machining, and the material and shape of workpiece W irradiated with laser light LB.

As described above, laser processing apparatus 100 according to the present exemplary embodiment includes at least laser oscillator 10 that generates laser light LB, optical fiber 30 that transmits laser light LB incident on incident end 30a, and laser head 40 that receives laser light LB transmitted by optical fiber 30 and emits laser light LB toward workpiece W.

Laser head 40 includes at least a second housing (housing) 41, first shield glass (first optical component) 45 and second shield glass (second optical component) 47 arranged inside second housing 41, and first light receiver 51 and second light receiver 52 arranged inside second housing 41.

First shield glass 45 is disposed at a position closer to emission end 30b of optical fiber 30 than second shield glass 47.

First shield glass 45 is provided with first coating film 46 having a predetermined reflectance on at least one surface of the light receiving surface of laser light LB, and second shield glass 47 is provided with second coating film 48 on at least one surface of the light receiving surface of laser light LB.

First light receiver 51 receives laser light LB reflected by first coating film 46 and outputs the first light receiving signal, and second light receiver 52 receives laser light LB reflected by peripheral portion 48b of second coating film 48 and outputs the second light receiving signal.

Laser processing apparatus 100 further includes controller 60 to which the first light receiving signal and the second light receiving signal are input. Controller 60 is configured to detect a change in NA of laser light LB incident on optical fiber 30 based on an intensity ratio between the first light receiving signal and the second light receiving signal.

With such a configuration of laser processing apparatus 100, it is possible to detect the reflected light corresponding to central portion 48a and peripheral portion 48b (see FIG. 4) of the beam profile of laser light LB, and to obtain the first light receiving signal and the second light receiving signal corresponding to the respective intensities. As a result, the NA of laser light LB and the change thereof can be monitored in real time. In addition, when laser light LB enters, first light receiver 51 and second light receiver 52 immediately output the first light receiving signal and the second light receiving signal. As a result, the NA of laser light LB and the change thereof can be detected in a short time.

In the conventional method disclosed in PTL 1, as described above, since the refractive index distribution of the condensing lens is indirectly obtained using a thermocouple, it takes a long time to detect the change in the focal distance. For this reason, it takes time to correct the focal position, and there is a possibility that the laser processing cannot be appropriately performed.

In particular, in a case where the NA of laser light LB changes with a change in the state of laser oscillator 10 or a change in the output of laser light LB, it is difficult to detect the change in a short time by the conventional method disclosed in PTL 1.

On the other hand, according to the present exemplary embodiment, the NA of laser light LB and the change thereof are detected in a short time based on the first light receiving signal and the second light receiving signal that are electric signals generated by first light receiver 51 and second light receiver 52, respectively. As a result, the NA of the laser beam and the spot diameter of laser light LB with which workpiece W is irradiated can be maintained at appropriate values by adjusting the position of each component inside laser processing apparatus 100.

In addition, the reflectance of peripheral portion 48b of second coating film 48 is set higher than the reflectance of first coating film 46.

In this way, the amount of reflected light incident on second light receiver 52 can be increased, and the intensity of the second light receiving signal can be increased. As a result, the NA of laser light LB and the change thereof can be accurately detected.

Laser processing apparatus 100 further includes optical coupler 20 for causing laser light LB emitted from laser oscillator 10 to be incident on incident end 30a of optical fiber 30.

By providing optical coupler 20, laser light LB can be reliably incident on optical fiber 30 and transmitted toward laser head 40.

In a case where the NA of laser light LB exceeds the predetermined range, controller 60 controls optical coupler 20 so that the NA falls within the predetermined range. Specifically, the position of reflection mirror 22 and/or first condensing lens 23 is adjusted by driving and controlling first position adjuster 71 connected to reflection mirror 22 and/or second position adjuster 72 connected to first condensing lens 23 provided inside optical coupler 20. As a result, the NA of laser light LB incident on optical fiber 30 is changed to fall within a desired range.

With such a configuration of controller 60, even in a case where the NA of laser light LB changes due to a state change of laser oscillator 10 or a sudden change in the output of laser light LB, it is possible to immediately detect the NA and keep the NA within a desired range. As a result, the beam quality of laser light LB with which workpiece W is irradiated, and thus the machining accuracy of workpiece W can be maintained.

Controller 60 controls laser head 40 so that laser light LB is condensed at a desired condensing position. Specifically, the position of collimation lens 42 and/or second condensing lens 43 is adjusted by driving and controlling third position adjuster 73 connected to collimation lens 42 and/or second condensing lens 43 provided inside laser head 40. As a result, laser light LB is condensed at a desired condensing position.

With this configuration of controller 60, the spot diameter of laser light LB applied to workpiece W can be reliably maintained at an appropriate value, and workpiece W can be subjected to laser machining with desired machining accuracy.

Optical fiber 30 includes first core 31 at the axial center, and first cladding 32 provided coaxially with first core 31 in contact with the outer peripheral surface of first core 31. In addition, optical fiber 30 includes at least second core 33 provided coaxially with first core 31 in contact with the outer peripheral surface of first cladding 32.

Optical fiber 30 may be configured as described above. As will be described later, by changing the spot diameter or irradiation position of laser light LB on incident end surface 30a1 of optical fiber 30, workpiece W can be irradiated with laser light LB having a desired beam profile.

Note that the type of optical fiber 30 used in laser processing apparatus 100 of the present disclosure is not particularly limited to the example illustrated in FIG. 2. For example, a single core structure including only first core 31 and first cladding 32 may be used.

In addition, in the example illustrated in FIG. 3, first coating film 46 is provided on a part of the surface of first shield glass 45, but the present invention is not particularly limited thereto. For example, first coating film 46 may be provided on a surface of first shield glass 45 on a side far from emission end 30b of optical fiber 30, or first coating film 46 may be provided on the entire surface of first shield glass 45.

Similarly, second coating film 48 may be provided on the surface of second shield glass 47 on a side farther from emission end 30b of optical fiber 30, or second coating film 48 may be provided on the entire surface of second shield glass 47. However, in this case, both central portion 48a and peripheral portion 48b need to be disposed in the optical path of laser light LB.

In addition, one or both of first shield glass 45 and second shield glass 47 may be omitted. When one is omitted, for example, second coating film 48 is provided on the surface of collimation lens 42 on a side close to emission end 30b of optical fiber 30. Second coating film 48 may be provided on the entire surface of collimation lens 42.

In addition, when both first shield glass 45 and second shield glass 47 are omitted, first coating film 46 may be provided on the surface of collimation lens 42 on a side close to emission end 30b of optical fiber 30. In this case, second coating film 48 may be provided on the surface of second condensing lens 43 on a side farther from the emission end 30b of optical fiber 30. However, in either case, both central portion 48a and peripheral portion 48b need to be disposed in the optical path of laser light LB.

That is, the above-described first optical component is not limited to first shield glass 45, and the second optical component is not limited to first shield glass 45.

In laser processing apparatus 100 of the present disclosure, first coating film 46 may be provided on at least one surface of the light receiving surface of laser light LB in the first optical component, and second coating film 48 may be provided on at least one surface of the light receiving surface of laser light LB in the second optical component.

### Second Exemplary Embodiment

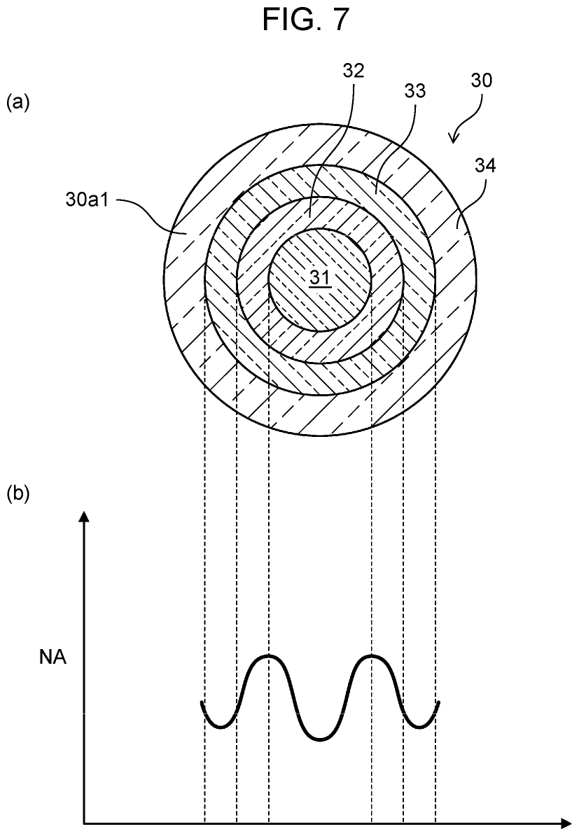

FIG. 7 illustrates a relationship between the incident position of the laser light on the incident end surface of the optical fiber and the NA of the laser light emitted from the optical fiber according to the present exemplary embodiment. Part (a) of FIG. 7 schematically illustrates a cross-sectional structure of optical fiber 30, which is similar to FIG. 2. Part (b) of FIG. 7 illustrates the NA of laser light LB emitted from optical fiber 30. The horizontal axis in part (b) of FIG. 7 corresponds to the diameter direction of optical fiber 30. Note that, in FIG. 7 and each of the drawings shown below, the same portions as those of the first exemplary embodiment are denoted by the same reference numerals, and detailed explanation thereof is omitted.

On incident end surface 30a1 of optical fiber 30 having the structure illustrated in FIG. 3, the divergence angle θ of laser light LB emitted from optical fiber 30, that is, the NA of laser light LB emitted from optical fiber 30 changes depending on the position where laser light LB is incident. As illustrated in FIG. 7, when laser light LB enters only first core 31 or second core 33, the NA of laser light LB emitted from optical fiber 30 has a small value. On the other hand, when laser light LB enters not only first core 31 and second core 33 but also first cladding 32, the NA of laser light LB emitted from optical fiber 30 increases. That is, the divergence angle of laser light LB increases.

Depending on a material and a processing form of workpiece W, a state in which the NA of laser light LB is large and laser light LB is expanded to some extent may be more appropriate than a state in which the NA of laser light LB emitted from optical fiber 30 is small and laser light LB is narrowed. For example, this is a case where a thin plate is cut.

In addition, when laser light LB is transmitted only to first core 31, the output of laser light LB applied to workpiece W may not reach a desired value. In such a case, the spot diameter of laser light LB on incident end surface 30a1 is expanded, laser light LB is also incident on second core 33, and the output of laser light LB applied to workpiece W is increased. At this time, laser light LB is also incident on first cladding 32, and the NA of laser light LB increases.

According to laser processing apparatus 100 of the present disclosure, the NA of laser light LB and the change thereof can be monitored in real time. In addition, the positions of reflection mirror 22 and first condensing lens 23 inside optical coupler 20 can be adjusted by driving first position adjuster 71 and/or second position adjuster 72.

As a result, for example, while the NA of laser light LB is monitored, the position of reflection mirror 22 is adjusted by first position adjuster 71, and the angle of the optical axis of laser light LB incident on optical fiber 30 can be changed. As a result, the NA of laser light LB can be increased, and workpiece W can be irradiated with laser light LB having a desired spot shape. In addition, while the NA of laser light LB is monitored, the position of first condensing lens 23 is adjusted by second position adjuster 72, and the spot diameter of laser light LB on incident end surface 30a1 can be expanded. As a result, the output of laser light LB applied to workpiece W can be increased.

That is, controller 60 of the present exemplary embodiment changes at least one of the incident position and the spot diameter of laser light LB on incident end surface 30a1 of optical fiber 30, and drives and controls optical coupler 20, specifically, at least one of first position adjuster 71 and second position adjuster 72 such that the NA of laser light LB becomes a desired value.

### Third Exemplary Embodiment

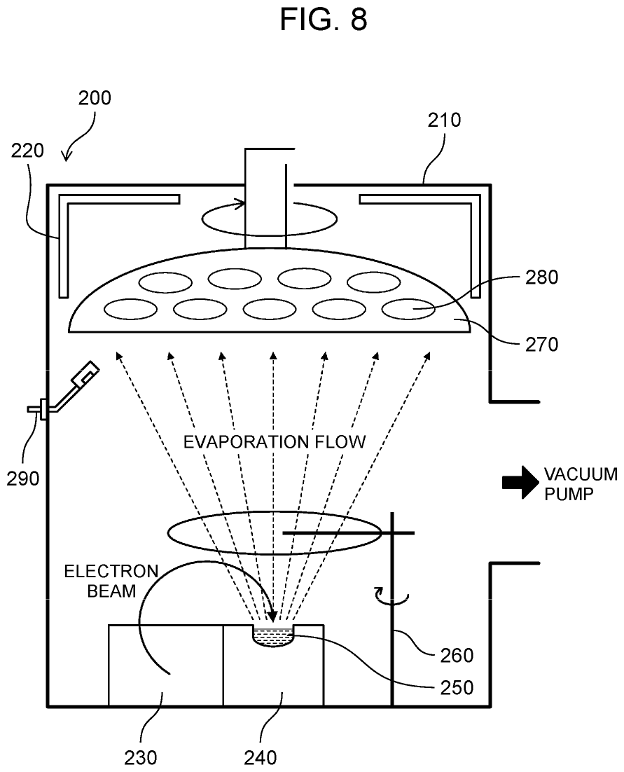

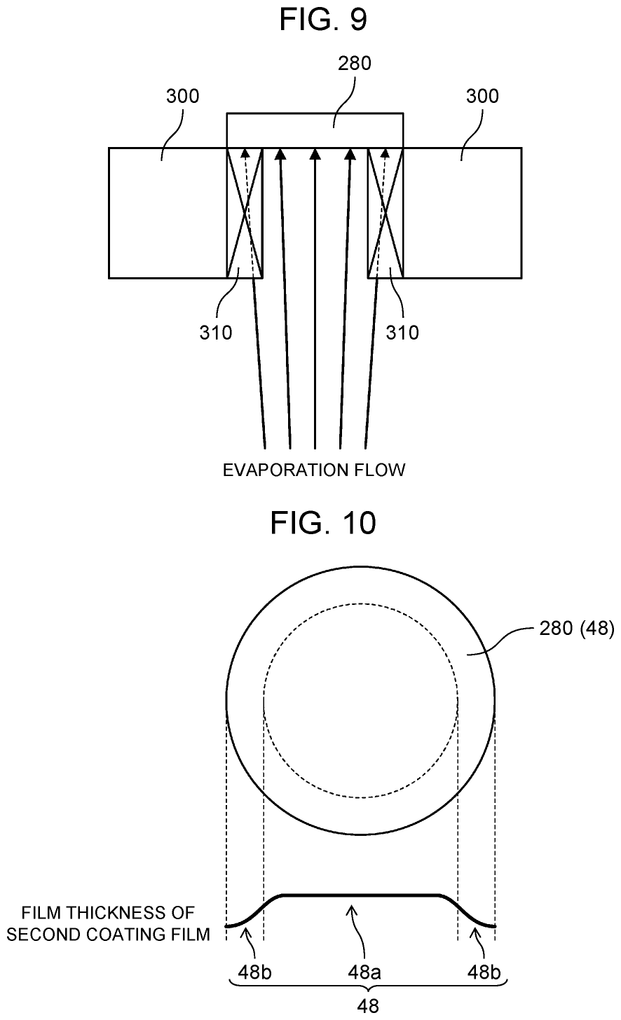

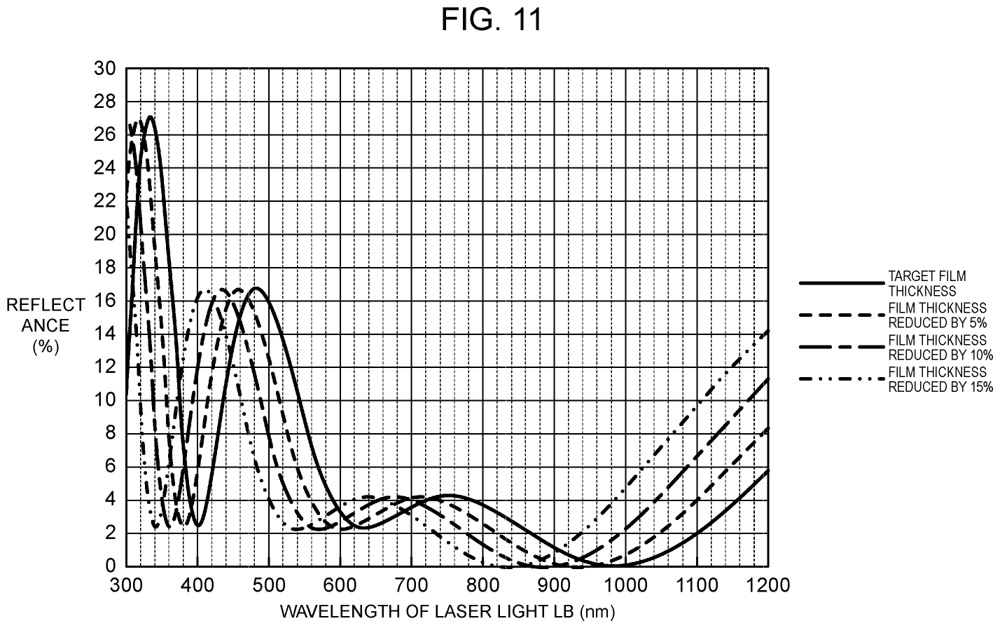

FIG. 8 is a schematic configuration diagram of a film forming apparatus for forming a second coating film according to the present exemplary embodiment, and FIG. 9 illustrates an arrangement relationship between an optical component and a fixture during film formation. FIG. 10 illustrates the film thickness distribution of the second coating film, and FIG. 11 illustrates the relationship between the wavelength of the laser light and the reflectance of the second coating film.

Second coating film 48 is formed on the surface of optical component 280 using, for example, the film forming apparatus 200 illustrated in FIG. 8. In the present exemplary embodiment, tantalum oxide will be described as an example of second coating film 48.

The film forming apparatus 200 includes vacuum chamber 210, heater 220, crucible 240 for electron gun 230, shutter 260, and substrate dome 270.

After the inside of vacuum chamber 210 is brought into a vacuum state by a vacuum pump (not illustrated), vapor deposition source 250 disposed in crucible 240. In this case, the ceramic molded body of tantalum oxide is irradiated with an electron beam from electron gun 230 to evaporate vapor deposition source 250.

Substrate dome 270 is disposed above vapor deposition source 250. Substrate dome 270 is attached to the inner surface of vacuum chamber 210 and is rotatable by a motor (not illustrated) or the like. In addition, substrate dome 270 is provided with a plurality of fixtures 300 illustrated in FIG. 9, and optical component 280 such as second shield glass 47 is held by each of the plurality of fixtures 300. Fixture 300 is a so-called substrate holder, and is open at the center and holds optical component 280 at the peripheral edge of the opening. In addition, substrate dome 270 and optical component 280 held by substrate dome 270 are heated by heater 220 disposed around the substrate dome to a predetermined temperature.

In a state where optical component 280 is disposed on fixture 300 and substrate dome 270 rotates, the vapor deposition source 250 is irradiated with an electron beam, and a constituent material of the vapor deposition source 250 becomes an evaporation flow. At this point, substrate dome 270 and optical component 280 are heated. When shutter 260 that has been closed is opened after the evaporation flow is stabilized, the evaporation flow flows toward substrate dome 270, the evaporation flow adheres to optical component 280 through the opening of fixture 300, and the deposition of second coating film 48 is started. By opening shutter 260 for a predetermined time, second coating film 48 having a desired film thickness is formed on the surface of optical component 280. Note that the film thickness of second coating film 48 is monitored by quartz film thickness meter 290 attached near substrate dome 270, and when the film thickness reaches a desired film thickness, shutter 260 is closed and the film formation is completed.

Usually, the film thickness of second coating film 48 formed in this manner rapidly decreases at the peripheral edge. On the other hand, in the film forming apparatus 200 illustrated in the present exemplary embodiment, mesh portion 310 is provided in the inner peripheral portion of the opening of fixture 300. Mesh portion 310 includes a plurality of openings (not illustrating) passing through the fixture 300 in the thickness direction, and is set such that the dimension of the opening decreases from the inner peripheral edge of the opening toward the outside.

When optical component 280 is held on fixture 300 provided with mesh portion 310 and second coating film 48 is formed, the film thickness distribution becomes a distribution in which the film thickness gradually decreases from central portion 48a to peripheral portion 48b as illustrated in FIG. 10.

For example, when the wavelength of laser light LB is set to about 950 nm to 1000 nm, the reflectance can be made substantially 0 as illustrated in FIG. 11 by setting the film thickness of second coating film 48 to a predetermined value. When the film thickness at this time is set to a target film thickness, the reflectance of second coating film 48 can be set to about 1% to 5% by reducing the film thickness by 5% to 15% from the target film thickness.

That is, by setting the film thickness distribution of second coating film 48 to the distribution as illustrated in FIG. 10, the reflectance of peripheral portion 48b can be higher than that of central portion 48a.

Note that the present exemplary embodiment is merely an example, and the reflectance may be increased by making the film thickness of peripheral portion 48b larger than the film thickness of central portion 48a depending on the structure and material of second coating film 48.

However, it is generally known that not only a single layer film or a laminated film but also a dielectric film changes the wavelength dependence of reflectance to light by changing the film thickness thereof. Therefore, by making the film thickness of central portion 48a of second coating film 48 different from the film thickness of peripheral portion 48b, the reflectance of peripheral portion 48b can be made higher than that of central portion 48a.

### Other Exemplary Embodiments

In the present specification, the case where laser oscillator 10 is a DDL light source has been described as an example, but the present invention is not particularly limited thereto. For example, laser oscillator 10 may be a solid-state laser light source, a gas laser light source, or a fiber laser light source.

### INDUSTRIAL APPLICABILITY

The laser processing apparatus of the present disclosure can detect the numerical aperture of the laser light and the change in the numerical aperture in a short time and in real time, and is useful for maintaining the processing accuracy of the workpiece.

### REFERENCE MARKS IN THE DRAWINGS

10: laser oscillator

20: optical coupler

21: first housing

22: reflection mirror

23: first condensing lens

30: optical fiber

30a: incident end

30a1: incident end surface

30b: emission end

31: first core

32: first cladding

33: second core

34: second cladding

40: laser head

41: second housing (housing)

42: collimation lens

43: second condensing lens

44: protective glass

45: first shield glass (first optical component)

46: first coating film

47: second shield glass (second optical component)

48: second coating film

48a: central portion

48b: peripheral portion

51: first light receiver

52: second light receiver

60: controller

71 to 73: first to third position adjusters

100: laser processing apparatus

200: film forming apparatus

210: vacuum chamber

270: substrate dome

300: fixture

310: mesh portion

LB: laser light

W: workpiece

1. A laser processing apparatus comprising:
a laser oscillator configured to generate laser light;
an optical fiber configured to transmit the laser light incident on an incident end; and
a laser head configured to receive the laser light transmitted through the optical fiber and irradiate a workpiece with the laser light, wherein
the laser head includes:
a housing;
a first optical component and a second optical component each disposed inside the housing; and
a first light receiver and a second light receiver each disposed inside the housing,
wherein the first optical component is disposed at a position closer to an emission end of the optical fiber than the second optical component is,
the first optical component is provided with a first coating film having a predetermined reflectance on at least one of light receiving surfaces of the laser light,
the second optical component is provided with a second coating film on at least one of light receiving surfaces of the laser light,
the first light receiver receives the laser light reflected by the first coating film and outputs a first light receiving signal corresponding to the laser light received, and
the second light receiver receives the laser light reflected by a peripheral portion of the second coating film and outputs a second light receiving signal corresponding to the laser light received.

2. The laser processing apparatus according to claim 1, wherein a reflectance of the peripheral portion of the second coating film is higher than the predetermined reflectance of the first coating film.

3. The laser processing apparatus according to claim 1, wherein the optical fiber includes at least:
a first core at an axial center;
a first cladding provided coaxially with the first core in contact with an outer peripheral surface of the first core; and
a second core provided coaxially with the first core in contact with an outer peripheral surface of the first cladding.

4. The laser processing apparatus according to claim 1, further comprising a controller to which the first light receiving signal and the second light receiving signal are input, wherein the controller is configured to detect a change in a numerical aperture of the laser light incident on the optical fiber based on an intensity ratio between the first light receiving signal and the second light receiving signal.

5. The laser processing apparatus according to claim 4, further comprising an optical coupler configured to cause the laser light emitted from the laser oscillator to enter the incident end of the optical fiber.

6. The laser processing apparatus according to claim 5, wherein when the numerical aperture exceeds a predetermined range, the controller controls the optical coupler, the numerical aperture falling within the predetermined range.

7. The laser processing apparatus according to claim 5, wherein the controller changes at least one of an incident position and a spot diameter of the laser light on an incident end surface of the optical fiber, and controls the optical coupler, the numerical aperture having a desired value.

8. The laser processing apparatus according to claim 4, wherein the controller causes the laser head to condense the laser light at a desired condensing position.

9. The laser processing apparatus according to claim 1, wherein a film thickness of a central portion of the second coating film is different from a film thickness of the peripheral portion.

10. The laser processing apparatus according to claim 9, wherein the film thickness of the central portion is larger than the film thickness of the peripheral portion.
